(19) United States
(12) Patent Application Publication
(10) Pub. No.: US 2024/0066636 A1
(43) Pub. Date: Feb. 29, 2024

(54) Laser Protection System

(71) Applicants: Hyundai Motor Company, Seoul (KR); Kia Corporation, Seoul (KR)

(72) Inventor: Hyun Jun Yoon, Goyang-si (KR)

(21) Appl. No.: 18/133,018

(22) Filed: Apr. 11, 2023

(30) Foreign Application Priority Data
Aug. 31, 2022 (KR) 10-2022-0109549

(51) Int. Cl. B23K 26/70

(52) U.S. Cl. CPC B23K 26/706

(57) ABSTRACT

The present disclosure provides a laser protection system including a laser source configured to sequentially radiate a laser beam to two or more work targets that are discretely supplied, a plurality of protective lenses disposed between the laser source and the work targets, the plurality of protective lenses each allowing the laser beam to pass therethrough at different times, and a drive mechanism having the plurality of protective lenses movably mounted thereon.

### CROSS-REFERENCE TO RELATED APPLICATION

This application claims, under 35 U.S.C. § 119(a), the benefit of and priority to Korean Patent Application No. 10-2022-0109549, filed on Aug. 31, 2022, the entire contents of which are incorporated herein by reference.

### BACKGROUND

### (a) Technical Field

The present disclosure relates to a laser protection system and, more particularly, to a laser protection system capable of protecting a laser during laser welding.

### (b) Discussion of the Background

A rechargeable secondary battery has recently been expanding its application for various reasons (e.g., the eco-friendly nature thereof). The field to which the secondary battery is applied may be, for example, an electric vehicle.

An electric vehicle includes a vehicle driven by a motor and is provided with a secondary battery as an energy storage configured to drive the motor. The battery installed in the electric vehicle may be assembled successively through a battery cell, a battery module, and then a battery pack. The battery may be finally mounted in the vehicle as the battery pack. The battery module may be manufactured by assembling a plurality of battery cells. Here, each battery cell of the plurality of battery cells may be welded to one another for electrical communication. During the assembly process, the quality of welding between the cells may play a significant role in determining cell performance.

The assembly process of the battery including the welding process of the cells may be conducted through an automated system. However, in the automated system, it may be highly likely that some defects in the weld between the cells causes overall defects. In such a case, production could be severely disrupted. Therefore, it is imperative to manage the assembly process such that welding defects do not occur.

The above information disclosed in this Background section is only for enhancement of understanding of the background of the present disclosure. Therefore, it may contain information that does not form the prior art that is already known to a person of ordinary skill in the art.

### SUMMARY

The following summary presents a simplified summary of certain features. The summary is not an extensive overview and is not intended to identify key or critical elements.

It is an object of the present disclosure to provide a laser protection system capable of preventing deterioration or defect of welding quality of a battery.

The object of the present disclosure is not limited to the above-mentioned object. Other objects not mentioned will be clearly understood by those of ordinary skill in the art to which the present disclosure pertains (hereinafter, “those skilled in the art”) based on the description below.

In one aspect, the present disclosure provides a laser protection system. The system includes a laser source configured to sequentially direct a laser beam to two or more work targets that are supplied, a plurality of protective lenses disposed between the laser source and the work targets, each of the plurality of protective lenses allowing the laser beam to pass therethrough at different times, and a drive mechanism having the plurality of protective lenses movably mounted thereon.

In another aspect, the present disclosure provides a method of operating a laser protection system. The method includes supplying a plurality of work targets disposed at an interval on a conveyor belt that is configured to move, aligning a laser source configured to perform laser welding with a first work target among the plurality of work targets, placing a first protective lens at an operating position positioned between the first work target and the laser source, performing laser welding on the first work target by the laser source, aligning a second work target with the laser source after completing the laser welding on the first work target, moving the first protective lens from the operating position to a first non-operating position and moving a second protective lens to the operating position, and performing laser welding on the second work target by the laser source.

A laser protection system may comprise: a laser source configured to sequentially emit a plurality of laser beams to a plurality of work targets that are discretely supplied; a plurality of protective lenses disposed between the laser source and the plurality of work targets; and a drive mechanism on which the plurality of protective lenses are movably mounted, wherein the drive mechanism is configured to move the plurality of protective lenses to allow each laser beam of the plurality of laser beams to pass through one of the plurality of protective lenses at a different time.

The drive mechanism may comprise: a protective lens conveyor, on which the plurality of protective lenses are mounted, configured to move the plurality of protective lenses in a direction parallel to a moving direction of the plurality of work targets; and a conveyor motor configured to provide a moving force to the protective lens conveyor.

The laser protection system may further comprise a cleaning member configured to clean the plurality of protective lenses.

The plurality of protective lenses may comprise a first protective lens and a second protective lens. The first protective lens may be placed at an operating position aligned with the laser source and a first work target of the plurality of work targets to allow a first laser beam of the plurality of laser beams to pass through the first protective lens. The second protective lens may be placed at a non-operating position. The cleaning member may be disposed at the non-operating position to clean the second protective lens.

The cleaning member may comprise: a brush element disposed to clean one of the plurality of protective lenses; and a rotation motor configured to rotate the brush element.

The cleaning member may further comprise a linear mover configured to move the cleaning member so that the brush element contacts a first protective lens of the plurality of protective lenses and the brush element is spaced apart from a second protective lens of the plurality of protective lenses.

The plurality of work targets may comprise a first work target and a second work target that are sequentially supplied. The drive mechanism may be configured to move a first protective lens of the plurality of protective lenses to be positioned between the first work target and the laser source when a first laser beam of the plurality of laser beams is radiated to the first work target. The drive mechanism may be configured to move a second protective lens of the plurality of protective lenses to be positioned between the second work target and the laser source when a second laser beam of the plurality of laser beams is radiated to the second work target.

The laser protection system may further comprise a laser source conveyor configured to move the laser source in a direction parallel to a moving direction of the plurality of work targets.

The laser protection system may further comprise a controller configured to control the laser source.

A method may comprise: supplying a plurality of work targets disposed at an interval on a conveyor belt that is configured to move the plurality of work targets; setting a laser source configured to perform a first laser welding operation on a first work target of the plurality of work targets; placing a first protective lens at an operating position positioned between the first work target and the laser source; performing the first laser welding operation on the first work target by using the laser source; aligning a second work target of the plurality of work targets with the laser source after completing the laser welding operation on the first work target; moving the first protective lens from the operating position to a non-operating position and moving a second protective lens to the operating position; and performing a second laser welding operation on the second work target by using the laser source.

The method may comprise cleaning the first protective lens while the first protective lens is positioned at the non-operating position.

The method may comprise: aligning a third work target of the plurality of work targets with the laser source after completing the second laser welding operation on the second work target; moving the second protective lens to the non-operating position or a second non-operating position, and moving the first protective lens from the non-operating position to the operating position; and performing a third laser welding operation on the third work target by using the laser source.

The method may comprise: moving the second protective lens to the non-operating position; and cleaning the second protective lens while the second protective lens is positioned at the non-operating position.

The conveyor belt may be operated by a conveyor belt motor.

The method may comprise: switching, by using a protective lens conveyor, positions of the first protective lens and the second protective lens between the operating position and the non-operating position, wherein the protective lens conveyor is operated by a conveyor motor.

The cleaning the second protective lens may comprise rotating a brush element of a cleaning member. The cleaning member may comprise the brush element and a rotation motor configured to rotate the brush element.

The method may comprise moving, by a linear mover, the cleaning member so that the cleaning member contacts the second protective lens.

The method may comprise moving the laser source in a direction parallel to a moving direction of the conveyor belt.

The operating position may be disposed between the non-operating position and a second non-operating position.

Each of the plurality of work targets may comprise a battery module comprising a plurality of cells, and the first laser welding operation and the second laser welding operation may be performed to electrically connect cells in the plurality of cells.

Other aspects of the disclosure are discussed in greater detail below.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

These and other features and advantages are described in greater detail below.

### BRIEF DESCRIPTION OF THE DRAWINGS

The above and other features of the present invention will now be described in detail with reference to various examples thereof illustrated in the accompanying drawings which are given hereinbelow by way of illustration only, and thus are not limitative of the present disclosure, and wherein:

FIG. 1 is a schematic view illustrating cell to cell welding in a battery module;

FIG. 2 is a top view of a laser protection system;

FIG. 3 is a front view of a laser protection system;

FIG. 4 is a front view of a laser protection system;

FIG. 5 is a front view of a disk illustrated in FIG. 4;

FIG. 6 illustrates the operation of a cleaning member of a laser protection system;

FIG. 7 illustrates a protective lens and a cleaning member of a laser protection system; and

FIGS. 8A, 8B, 8C, 8D, and 8E illustrate an example operation of a laser protection system.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Descriptions of specific structures or functions presented in various examples of the present disclosure are merely exemplary for the purpose of explaining the features according to the concept of the present invention, and the features according to the concept of the present invention may be implemented in various forms. In addition, the descriptions should not be construed as being limited to the examples described herein, and should be understood to include all modifications, equivalents and substitutes falling within the idea and scope of the present disclosure.

Meanwhile, in the present disclosure, terms such as “first” and/or “second” may be used to describe various components, but the components are not limited by the terms. These terms are only used to distinguish one component from another. For example, a first component could be termed a second component. Similarly, a second component could be termed a first component, without departing from the scope of the present disclosure.

It will be understood that when a component is referred to as being “connected to” another component, the component can be directly connected to the other component, or intervening components may also be present. In contrast, when a component is referred to as being “directly connected to” another component, there are no intervening components present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating various examples and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

Hereinafter, various examples of the present disclosure will be described in detail with reference to the accompanying drawings.

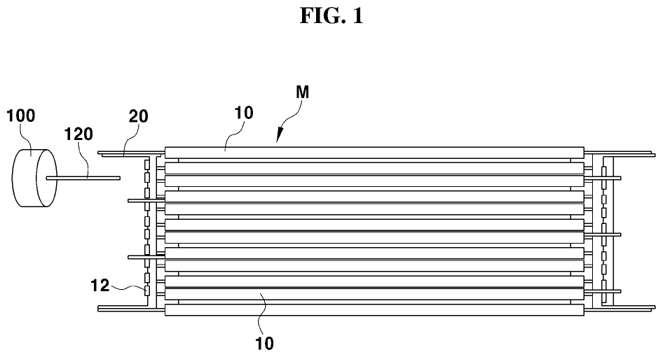

FIG. 1 is a schematic view illustrating cell to cell welding in a battery module. As illustrated in FIG. 1, a battery module M may be electrically configured to connect cells 10 where the cells 10 are stacked on one another. The battery module M may be assembled in an enclosure. In the depicted example, the battery module M may be in a state before being assembled in the enclosure. For example, a sensing module 20 for electrically connecting the cells 10 may be mounted on the stacked cells 10. Each of the cells 10 may have a lead 12 bent to be bonded to the sensing module 20, and the bonded lead 12 may be laser welded by a laser source 100. The laser source 100 may emit a laser beam 120.

In order to prevent spatters and fumes generated during laser welding from reaching the laser source 100, a protective lens 200 configured to protect the laser source 100 from the foreign substances may be provided. However, the protective lens 200 may also be contaminated due to a long use. If the protective lens 200 is contaminated, it may cause deterioration of the quality of a welded portion or defects in the welded portion, for example, due to a decrease in the output of the laser source 100, etc.

If the protective lens 200 is contaminated, welding defects may be caused by insufficient heat input of a welding material. Since it may be difficult to monitor such welding defects in an automated system, monitoring by an operator is being done. Such a monitoring process results in decrease in productivity and increase in manufacturing cost. In addition, factors, such as regular maintenance for maintaining welding quality and the time consumed to resolve defects when the defects are found, may further decrease productivity and increase maintenance items.

For this reason, the present disclosure provides a laser protection system capable of maintaining welding quality at a certain level by automatically handling foreign substances, such as spatters and fumes created during laser welding. The present disclosure aims to provide an automated device which can eliminate factors causing welding defects generated due to foreign substances in a protective lens and prevent decrease in productivity that may arise due to the required attention of a worker and a facility shutdown.

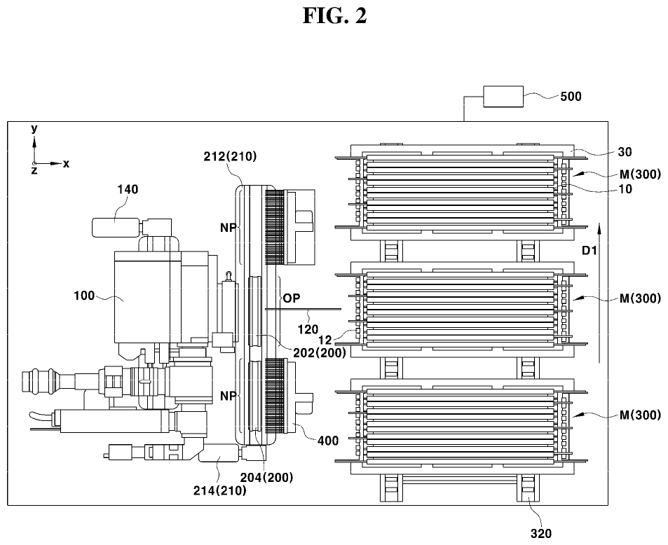

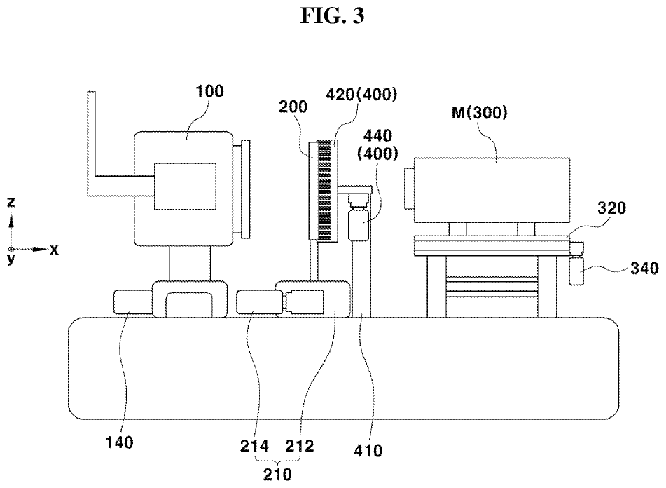

FIG. 2 is a top view of a laser protection system, and FIG. 3 is a front view of a laser protection system. Referring to FIGS. 2 and 3, the laser source 100 may be a laser welding apparatus, which is configured to emit a laser beam 120. The laser source 100 may irradiate a work target 300 with the laser beam 120 to weld an intended portion. The work target 300 and the laser source 100 may be aligned with each other so that the laser beam 120 may be focused on a portion of the work target 300 to be welded. The work target 300 may be the stacked cells 10 constituting the battery module M. In order for the cells 10 to be electrically connected, each of the cells 10 may have the lead 12 welded to the sensing module 20. The work target 300 may be a single item requiring welding or a plurality of items that are sequentially supplied. For example, the work target 300 may include a single battery module M or a plurality of battery modules M.

More than one work target 300 may be welded. A plurality of work targets 300 may be sequentially supplied for laser welding. To this end, the work targets 300 may be disposed at a predetermined interval on a conveyor belt 320 configured to move in a moving direction D1 (e.g., in a y-axis direction as shown in FIG. 2). Here, each of the work targets 300 may be fixed by a jig 30. The conveyor belt 320 may be configured to move or rotate. For example, the conveyor belt 320 may be movable by receiving a moving force from a conveyor belt motor 340.

The laser source 100 may be bidirectionally movable in the moving direction D1 (e.g., in the y-axis direction). The laser source 100 may include a laser source conveyor 140. As a non-limiting example, the laser source conveyor 140 may include a linear actuator and/or a cylinder actuator.

The laser protection system may include the protective lens 200. The protective lens 200 may prevent the laser source 100 from being contaminated by spatters, fumes, etc., generated during a laser welding. The protective lens 200 may be arranged in alignment with the laser source 100 so that the laser beam 120 passes therethrough.

The laser protection system may include one or more protective lenses 200. The one or more protective lenses 200 may be operatively associated with each other. A first protective lens 202, which may be one of the protective lenses 200, may be placed at an operating position OP used for protection of the laser source 100. A second protective lens 204, which may be another one of the protective lenses 200, may be placed at a non-operating position NP, which is in a standby state or a cleaning state. The first protective lens 202 may change its position with the second protective lens 204. For example, the first protective lens 202 and the second protective lens 204 may switch their positions with each other after the first protective lens 202 is at the operating position OP for a predetermined period. As another example, the first protective lens 202 and the second protective lens 204 may switch their positions with each other if the welding of one of the work targets 300 is completed at the operating position OP. The first protective lens 202 may move from the operating position OP to the non-operating position NP, while the second protective lens 204 is moved to the operating position OP. In other words, the first protective lens 202 and the second protective lens 204 alternately move from the operating position OP to the non-operating position NP, or from the non-operating position NP to the operating position OP. The laser protection system may further include more protective lenses in addition to the two protective lenses.

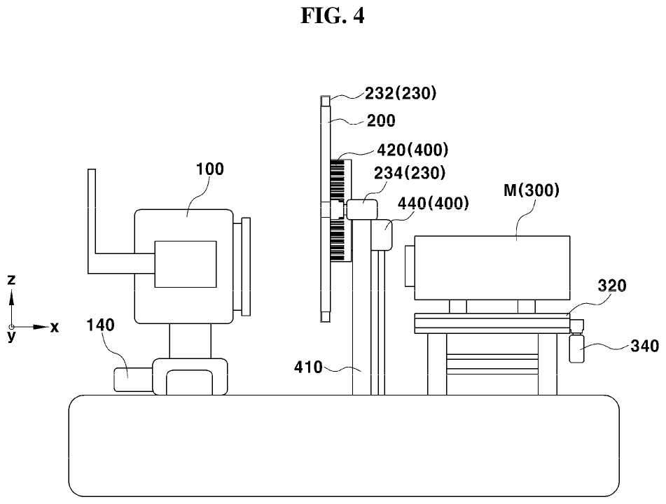

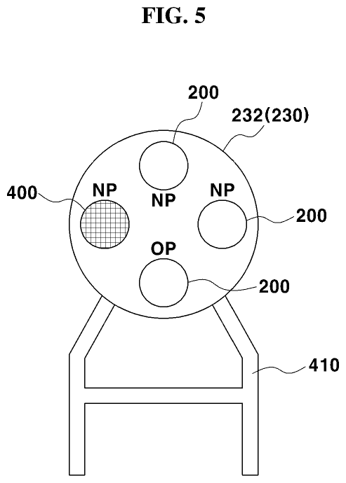

FIG. 4 is a front view of a laser protection system, and FIG. 5 is a front view of a disk illustrated in FIG. 4. The laser protection system may include drive mechanisms 210, 230 configured to move the protective lenses 200, for example, as shown in FIGS. 3, 4 and 5. The drive mechanism 210 may include a protective lens conveyor 212 and a conveyor motor 214. Two or more protective lenses 200 may be placed on the protective lens conveyor 212 at a certain distance apart from each other. The protective lens conveyor 212 may be moved by the conveyor motor 214 and may reciprocate in the moving direction D1 (e.g., the y-axis direction). As a non-limiting example, the protective lens conveyor 212 and the conveyor motor 214 may be a cylinder actuator, an orthogonal robot, or the like. Referring to FIGS. 4 and 5, the drive mechanism 230 may include a rotatable disk 232 and a disk motor 234. The protective lenses 200 may be arranged at a predetermined interval in a circumferential direction of the disk 232. The disk 232 may be configured to rotate by the disk motor 234. Welding may be performed by the laser source 100 through the protective lens 200 at the operating position OP. A pole 410 supporting the disk 232 may have a predetermined shape so as not to interfere with the operation performed through the operating position OP.

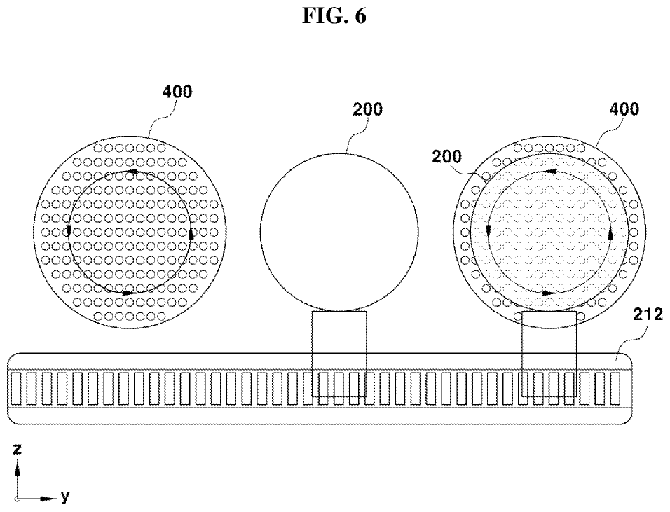

FIG. 6 illustrates the operation of a cleaning member of a laser protection system. As illustrated in FIG. 6, the protective lens 200 may be cleaned by a cleaning member 400. For example, the cleaning member 400 may be configured to clean the protective lens 200 positioned at the non-operating position NP. The cleaning member 400 may include a rotatable brush element 420 and a rotation motor 440 configured to rotate the brush element 420. If the drive mechanism 210 includes the one or more protective lenses 200 disposed in the moving direction D1, as shown in FIGS. 2 and 3, the cleaning member 400 may be placed at every non-operating position NP. In order to avoid the need for a separate lift device, a portion to which the laser beam 120 is irradiated, the protective lens 200, and the cleaning member 400 may all be provided at the same height on a z-axis.

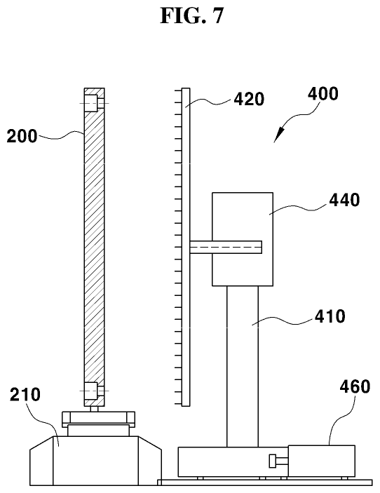

FIG. 7 illustrates a protective lens and a cleaning member of a laser protection system. As illustrated in FIG. 7, the cleaning member 400 may be movable in a direction perpendicular to the moving direction D1 (e.g., in the x-axis direction). To this end, the cleaning member 400 may be provided with a linear mover 460, such as a cylinder actuator. When the cleaning member 400 is not in operation, the cleaning member 400 may be spaced apart from the protective lens 200 by a predetermined distance. When the cleaning member 400 is in operation, the cleaning member 400 may be brought closer to the protective lens 200 at the non-operating position NP so that the brush element 420 comes into contact with the protective lens 200.

The laser protection system may further include a controller 500 (e.g., as shown in FIG. 2). The controller 500 may oversee (e.g., control) the operation of the movers such as the laser source conveyor 140, the conveyor motor 214, the disk motor 234, the conveyor belt motor 340, the linear mover 460, and/or the rotation motor 440. The controller 500 may operate the laser source 100 at a required point in time. As such, the controller 500 may integrally control the components of the laser protection system. In one or more configurations, each of the movers, the rotation motor 440, and the laser source 100 may be controlled by a separate controller. An actuator such as a motor may be a servomotor, and the servomotor may be controlled by the controller 500.

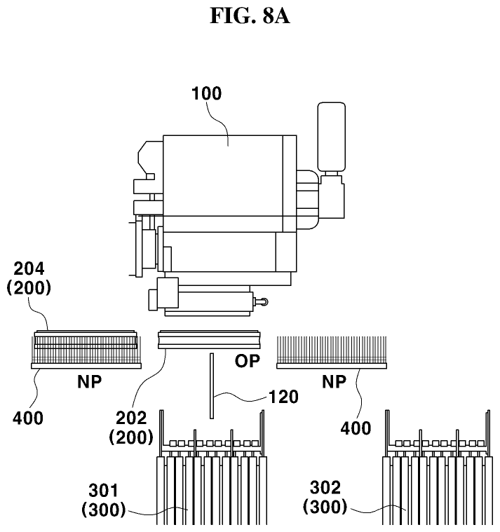

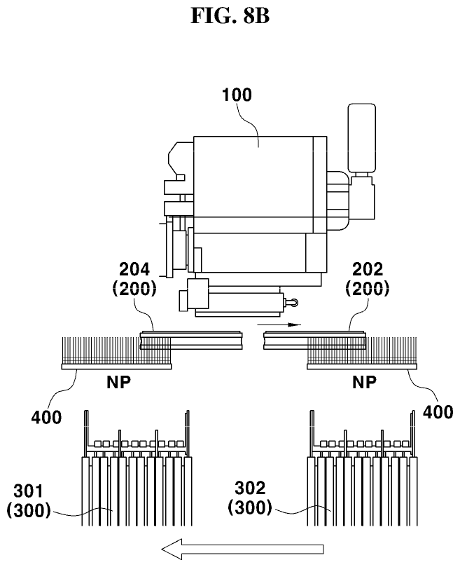

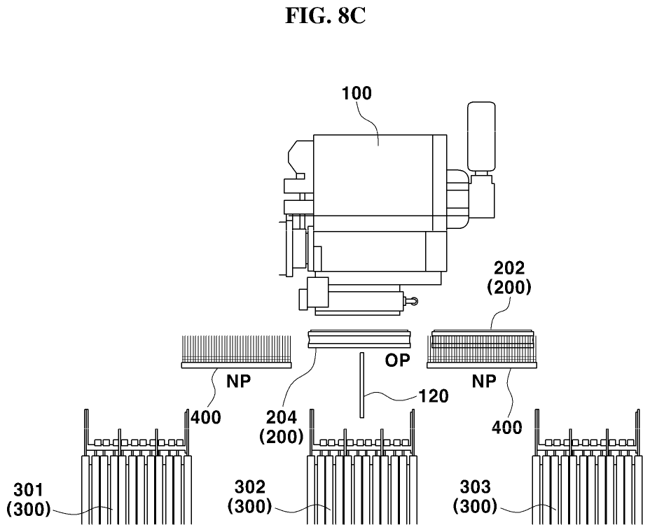

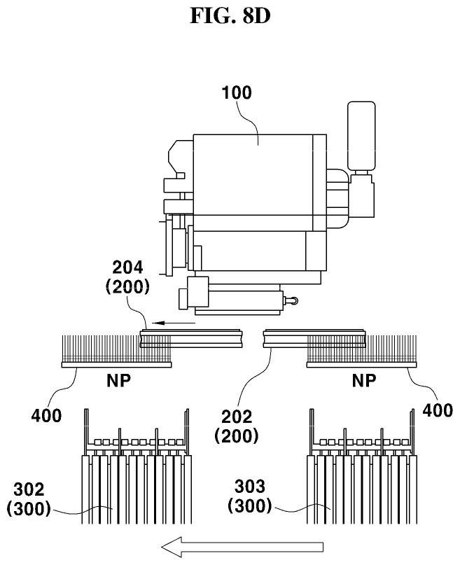

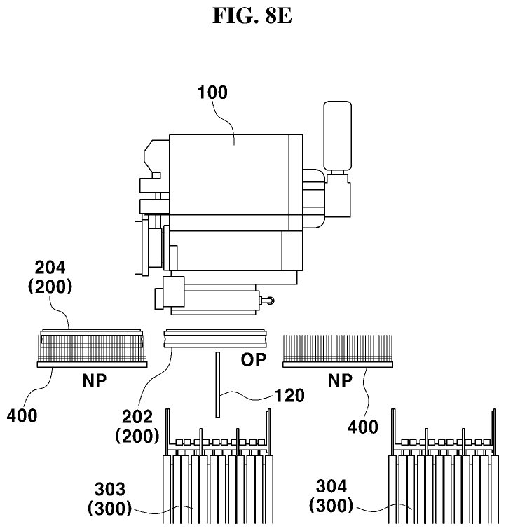

FIGS. 8A, 8B, 8C, 8D, and 8E illustrate an example operation of a laser protection system. An example operation of the laser protection system will be described with reference to FIGS. 8A to 8E.

As illustrated in FIG. 8A, the laser source 100 may be disposed to perform welding of a first work target 301. The first protective lens 202 may be disposed at the operating position OP. The laser beam 120 of the laser source 100 may be directed to the first work target 301 through the first protective lens 202. The cleaning member 400 may be disposed at the non-operating position NP disposed at one side of the operating position OP or at both sides of the operating position OP to clean the second protective lens 204. The controller 500 may operate the linear mover 460 (e.g., as shown in FIG. 7) to bring the cleaning member 400 into contact with the protective lens 200. The controller 500 may operate the rotation motor 440 to wipe the surface of the protective lens 200 with the rotating brush element 420, for example, if the cleaning member 400 contacts the protective lens 200.

Referring to FIGS. 8B and 8C, if laser welding of the first work target 301 is finished, a second work target 302 transported by the conveyor belt 320 may be placed at the operating position OP. At the same time, the first protective lens 202 at the operating position OP may switch the position thereof with the position of the second protective lens 204. The controller 500 may operate the conveyor motor 214 so that the second protective lens 204 moves to the operating position OP. If the second protective lens 204 is placed at the operating position OP, the laser source 100 may perform welding of the second work target 302. At this time, the surface of the first protective lens 202 at the non-operating position NP may be cleaned by the cleaning member 400.

Referring to FIGS. 8D and 8E, if the welding of the second work target 302 is completed, the controller 500 may operate the conveyor belt motor 340 to align a third work target 303, which is the next work target, placed on the conveyor belt 320 with the operating position OP. The controller 500 may operate the conveyor motor 214 to bring the first protective lens 202 back to the operating position OP, for example, as the third work target 303 is aligned with the operating position OP. The laser source 100 may perform welding on the third work target 303 according to the command of the controller 500. Welding may proceed while repeating the same process described above for a fourth work target 304 placed on the conveyor belt 320.

The laser protection system illustrated in FIGS. 4 and 5 may operate in a similar manner. If a laser welding process proceeds through the protective lens 200 at the operating position OP and the welding on the first work target 301 is completed, the controller 500 may rotate the disk motor 234 to move another protective lens 200 from the non-operating position NP to the operating position OP. At the non-operating position NP, cleaning by the cleaning member 400 is performed. Although only one cleaning member 400 is shown in the drawing, the cleaning member 400 may be further provided at each of the non-operating positions NP or may be selectively provided. For example, each non-operating position NP has a cleaning member 400.

When defects occur in the welding process during the automated battery pack manufacturing process, since there is a very high possibility that mass defects will occur, periodic monitoring and management may be needed. Defects in welding may be caused by, specifically, foreign substances, such as fume gas and spatter generated during the welding process, which contaminates the protective lens of the laser source thereby decreasing the output of the laser. However, even if the laser welding apparatus is regularly maintained, it may be difficult to predict the generation of foreign substances.

For this reason, the present disclosure proposes a system configured to automatically clean foreign substances attached to the protective lens of the laser welding apparatus, thereby greatly reducing defects caused by a decrease in laser output due to foreign substances and avoiding costs from disposal of products due to the defects.

Throughout the disclosure, various examples are described such that the laser protection system is applied to the welding process needed when assembling the battery. However, it will be apparent to those skilled in the art that the laser protection system according to the present disclosure may be applied to other systems to which an automated welding process as well as a battery assembly process is applied.

As is apparent from the above description, the present disclosure provides at least the following advantages.

The laser protection system may prevent or reduce deterioration in welding quality or defects in welding of a battery.

Advantageous effects of the proposed system and method are not limited to those described above, and other advantageous effects not mentioned will be clearly recognized by those skilled in the art based on the above description.

It will be apparent to those of ordinary skill in the art to which the present disclosure pertains that the present disclosure described above is not limited by the above-described examples and the accompanying drawings, and various substitutions, modifications and changes are possible within a range that does not depart from the technical idea of the present invention.

What is claimed is:

1. A laser protection system comprising:
a laser source configured to sequentially emit a plurality of laser beams to a plurality of work targets that are discretely supplied;
a plurality of protective lenses disposed between the laser source and the plurality of work targets; and
a drive mechanism on which the plurality of protective lenses are movably mounted, wherein the drive mechanism is configured to move the plurality of protective lenses to allow each laser beam of the plurality of laser beams to pass through one of the plurality of protective lenses at a different time.

2. The laser protection system according to claim 1, wherein the drive mechanism comprises:
a protective lens conveyor, on which the plurality of protective lenses are mounted, configured to move the plurality of protective lenses in a direction parallel to a moving direction of the plurality of work targets; and
a conveyor motor configured to provide a moving force to the protective lens conveyor.

3. The laser protection system according to claim 1, further comprising a cleaning member configured to clean the plurality of protective lenses.

4. The laser protection system according to claim 3, wherein the plurality of protective lenses comprises a first protective lens and a second protective lens,
wherein the first protective lens is placed at an operating position aligned with the laser source and a first work target of the plurality of work targets to allow a first laser beam of the plurality of laser beams to pass through the first protective lens,
wherein the second protective lens is placed at a non-operating position, and
wherein the cleaning member is disposed at the non-operating position to clean the second protective lens.

5. The laser protection system according to claim 3, wherein the cleaning member comprises:
a brush element disposed to clean one of the plurality of protective lenses; and
a rotation motor configured to rotate the brush element.

6. The laser protection system according to claim 5, wherein the cleaning member further comprises a linear mover configured to move the cleaning member so that the brush element contacts a first protective lens of the plurality of protective lenses and the brush element is spaced apart from a second protective lens of the plurality of protective lenses.

7. The laser protection system according to claim 1, wherein:
the plurality of work targets comprises a first work target and a second work target that are sequentially supplied, and
the drive mechanism is configured to move a first protective lens of the plurality of protective lenses to be positioned between the first work target and the laser source when a first laser beam of the plurality of laser beams is radiated to the first work target, and
the drive mechanism is configured to move a second protective lens of the plurality of protective lenses to be positioned between the second work target and the laser source when a second laser beam of the plurality of laser beams is radiated to the second work target.

8. The laser protection system according to claim 1, further comprising a laser source conveyor configured to move the laser source in a direction parallel to a moving direction of the plurality of work targets.

9. The laser protection system according to claim 1, further comprising a controller configured to control the laser source.

10. A method of operating a laser protection system, the method comprising:
supplying a plurality of work targets disposed at an interval on a conveyor belt that is configured to move the plurality of work targets;
setting a laser source configured to perform a first laser welding operation on a first work target of the plurality of work targets;
placing a first protective lens at an operating position positioned between the first work target and the laser source;
performing the first laser welding operation on the first work target by using the laser source;
aligning a second work target of the plurality of work targets with the laser source after completing the laser welding operation on the first work target;
moving the first protective lens from the operating position to a non-operating position and moving a second protective lens to the operating position; and
performing a second laser welding operation on the second work target by using the laser source.

11. The method according to claim 10, further comprising cleaning the first protective lens while the first protective lens is positioned at the non-operating position.

12. The method according to claim 10, further comprising:
aligning a third work target of the plurality of work targets with the laser source after completing the second laser welding operation on the second work target;
moving the second protective lens to the non-operating position or a second non-operating position, and moving the first protective lens from the non-operating position to the operating position; and
performing a third laser welding operation on the third work target by using the laser source.

13. The method according to claim 10, further comprising:
moving the second protective lens to the non-operating position; and
cleaning the second protective lens while the second protective lens is positioned at the non-operating position.

14. The method according to claim 10, wherein the conveyor belt is operated by a conveyor belt motor.

15. The method according to claim 10, further comprising:
switching, by using a protective lens conveyor, positions of the first protective lens and the second protective lens between the operating position and the non-operating position, wherein the protective lens conveyor is operated by a conveyor motor.

16. The method according to claim 13, wherein the cleaning the second protective lens comprises rotating a brush element of a cleaning member, and wherein the cleaning member comprises the brush element and a rotation motor configured to rotate the brush element.

17. The method according to claim 16, further comprising moving, by a linear mover, the cleaning member so that the cleaning member contacts the second protective lens.

18. The method according to claim 10, further comprising moving the laser source in a direction parallel to a moving direction of the conveyor belt.

19. The method according to claim 10, wherein the operating position is disposed between the non-operating position and a second non-operating position.

20. The method according to claim 10, wherein each of the plurality of work targets comprises a battery module comprising a plurality of cells, and wherein the first laser welding operation and the second laser welding operation are to electrically connect cells in the plurality of cells.
